(19) United States
(12) Patent Application Publication
(10) Pub. No.: US 2019/0066144 A1
(43) Pub. Date: Feb. 28, 2019

(54) COMPUTER SYSTEM AND A COMPUTER IMPLEMENTED METHOD FOR INCENTIVIZING A USER FOR PAYMENT CARD USAGE

(71) Applicant: MASTERCARD INTERNATIONAL INCORPORATED, PURCHASE, NY (US)

(72) Inventors: Jaipal Singh Kumawat, Sikar (IN); Sourabh Kumar Maheshwari, Ghaziabad (IN); Ankur Arora, New Delhi (IN)

(21) Appl. No.: 16/051,172

(22) Filed: Jul. 31, 2018

(30) Foreign Application Priority Data
Aug. 24, 2017 (SG) 10201706912X

(51) Int. Cl. G06Q 30/02; G06Q 20/34

(52) U.S. Cl. CPC G06Q 30/0226; G06Q 20/341; G06Q 30/0238

(57) ABSTRACT

A computer system for incentivizing a user for payment card usage, includes a memory device configured to store machine-readable instructions and a processor operably connected with the memory device. The processor obtains the machine-readable instructions from the memory device, and is configured by the machine-readable instructions to receive merchant transaction data pertaining to a merchant, determine a first variable from the merchant transaction data, receive user transaction data pertaining to a customer of the merchant, the customer being a user of a payment card, the user transaction data having a card component and a cash component, determine a second variable associated with the card component, from the user transaction data, determine a third variable associated with the cash component, from the user transaction data, and provide one or more rule based incentives to the customer, on a basis of the second variable and the third variable.

### CROSS-REFERENCE TO RELATED APPLICATION

This application claims the benefit of and priority to Singapore Patent Application No. 10201706912X filed Aug. 24, 2017. The entire disclosure of the above application is incorporated herein by reference.

### FIELD

The present disclosure generally relates to methods and systems for monitoring payment card usage and in particular to a computer system and a computer implemented method for incentivizing a user for payment card usage.

### BACKGROUND

This section provides background information related to the present disclosure which is not necessarily prior art.

Most of economies globally, both developed and developing, rely heavily on cash transactions. While cash transactions have been here for a long time and are a preferred mode of financial truncation among the users, they are facing a number of challenges in the modern world such as paper currency is highly susceptible to counterfeiting, printing, maintaining and safety of paper currency requires a large amount of capital investment on part of a government. Moreover, it is rather difficult to keep track of cash transactions and ensure that the cash transactions comply with regulatory standards of a jurisdiction.

It is therefore desirable for an economy to prosper and maintain regulatory compliances, that, as much as possible, the financial transactions should be cashless. Payment cards provide a viable alternative to cash based transactions. However, a large number of sections of the general public are still averse to do cashless financial transactions. Solutions have been provided in order to entice users to carry out transactions via payment cards. However, such type of solutions follow a very linear relationship to a total payment card usage and does not target and/or reward users according to their payment card usage per transaction patterns.

In light of the discussion above, there is need for a computer system and a computer implemented method incentivizing a user for payment card usage which distinguishes users as per their individual payment card usage patterns and incentivizes them accordingly.

Any discussion of the background art throughout the specification should in no way be considered as an admission that such background art is prior art nor that such background art is widely known or forms part of the common general knowledge in the field worldwide.

### SUMMARY

This section provides a general summary of the disclosure, and is not a comprehensive disclosure of its full scope or all of its features. Aspects and embodiments of the disclosure are set out in the accompanying claims.

According to a first aspect of the present disclosure, there is provided a computer system for incentivizing a user for payment card usage. The computer system includes a memory device configured to store machine-readable instructions and a processor operably connected with the memory device. The processor obtains the machine-readable instructions from the memory device, and is configured by the machine-readable instructions to receive merchant transaction data pertaining to a merchant. Further, the processor is configured by the machine-readable instructions to determine a first variable from the merchant transaction data. Further, the processor is configured by the machine-readable instructions to receive user transaction data pertaining to a customer of the merchant, the customer being a user of a payment card, the user transaction data having a card component and a cash component. Further, the processor is configured by the machine-readable instructions to determine a second variable associated with the card component, from the user transaction data. Further, the processor is configured by the machine-readable instructions to determine a third variable associated with the cash component, from the user transaction data. Also, the processor is configured by the machine-readable instructions to provide one or more rule based incentives to the customer, on a basis of the second variable and the third variable.

According to a second aspect of the present disclosure, there is provided a computer system for incentivizing a user for payment card usage. The computer system includes a memory device configured to store machine-readable instructions and a processor operably connected with the memory device. The processor obtains the machine-readable instructions from the memory device, and is configured by the machine-readable instructions to receive user transaction data pertaining to a user of a payment card, the user transaction data having a card component and a cash component. Further, the processor is configured by the machine-readable instructions to determine a second variable associated with the card component, from the user transaction data. Further, the processor is configured by the machine-readable instructions to determine a third variable associated with the cash component, from the user transaction data. Also, the processor is configured by the machine readable instructions to provide one or more rule based incentives to the user, on a basis of the second variable and the third variable.

According to a third aspect of the present disclosure, there is provided a computer implemented method for incentivizing a user for payment card usage. The computer implemented method includes a step of receiving merchant transaction data pertaining to a merchant, wherein the merchant transaction data comprises merchant Point of Sale (POS) data pertaining to the merchant. Further, the computer implemented method includes a step of determining a first variable from the merchant transaction data, wherein the merchant POS data pertains to a plurality of periods of time and the first variable is a percentage increase in a total periodic transaction amount, for a period of time during a spike event, compared to, a total periodic transaction amount, for a period of time before the spike event. Further, the computer implemented method includes a step of receiving user transaction data pertaining to a customer of the merchant, the customer being a user of a payment card, the user transaction data having a card component and a cash component. Further, the computer implemented method includes a step of determining a second variable associated with the card component, from the user transaction data, wherein the user transaction data pertains to the plurality of periods of time and the second variable is a percentage increase in a total periodic card component amount for the period of time during the spike event, compared to, a total periodic card component amount for the period of time before the spike event. Further, the computer implemented method includes a step of determining a third variable associated with the cash component, from the user transaction data, wherein the third variable is a total periodic cash component amount for the period of time before the spike event. Also, the computer implemented method includes a step of providing one or more rule based incentives to the customer, on a basis of the second variable and the third variable.

According to a fourth aspect of the present disclosure, there is provided a computer implemented method for incentivizing a user for payment card usage. The computer implemented method includes a step of receiving user transaction data pertaining to a user of a payment card, the user transaction data having a card component and a cash component. Further, the computer implemented method includes a step of determining a second variable associated with the card component, from the user transaction data, wherein the user transaction data pertains to a plurality of periods of time and the second variable is a percentage increase in a total periodic card component amount for a period of time during a spike event, compared to, a total periodic card component amount for a period of time before the spike event. Further, the computer implemented method includes a step of determining a third variable associated with the cash component, from the user transaction data, wherein the third variable is a total periodic cash component amount for the period of time before the spike event. Also, the computer implemented method includes a step of providing one or more rule based incentives to the user, on a basis of the second variable and the third variable.

According to a fifth aspect of the present disclosure, there is provided a non-transitory machine-readable medium. The non-transitory machine readable medium includes machine-readable instructions stored thereon, when executed by a processor, the machine-readable instructions cause the processor to receive merchant transaction data pertaining to a merchant. Further, the machine-readable instructions cause the processor to determine a first variable from the merchant transaction data. Further, the machine-readable instructions cause the processor to receive user transaction data pertaining to a customer of the merchant, the customer being a user of a payment card, the user transaction data having a card component and a cash component. Further, the machine-readable instructions cause the processor to determine a second variable associated with the card component, from the user transaction data. Further, the machine-readable instructions cause the processor to determine a third variable associated with the cash component, from the user transaction data. Also, the machine-readable instructions cause the processor to provide one or more rule based incentives to the customer, on a basis of the second variable and the third variable.

According to a sixth aspect of the present disclosure, there is provided a non-transitory machine-readable medium, including machine-readable instructions stored thereon, when executed by a processor, cause the processor to receive user transaction data pertaining to a user of a payment card, the user transaction data having a card component and a cash component, determine a second variable associated with the card component, from the user transaction data, determine a third variable associated with the cash component, from the user transaction data and provide one or more rule based incentives to the user, on a basis of the second variable and the third variable.

According to a seventh aspect of the present disclosure, there is provided a computer software program, including machine-readable instructions, when executed by a processor, causing the processor to perform the method of any one of the preceding method claims.

As used in this document, the term “payment card” refers to any suitable cashless payment device associated with a payment account. Thus the term includes physical cards, such as a credit card, a debit card, a prepaid card and a charge card. The physical payment card may carry payment account information, for example, it may comprise a Primary Account Number (PAN) of a payment card. Alternatively, the payment card may be implemented in software in an electronic device, such as a user's mobile communication device (e.g., smartphone or tablet computer). For example, the payment card may be an app or service running on the communication device which allows the user to make a payment or a digital wallet service, using an associated payment account.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. At least one example of the present disclosure will be described with reference to the accompanying drawings, in which:

FIG. 1A illustrates an exemplary environment of computing devices to which the various embodiments described herein may be implemented;

FIG. 1B illustrates a payment server, in accordance with an embodiment of the present disclosure;

FIG. 2 illustrates a computer implemented method for incentivizing a user for payment card usage, in accordance with an embodiment of the present disclosure; and

FIG. 3 illustrates a computer implemented method for incentivizing a user for payment card usage, in accordance with another embodiment of the present disclosure.

It should be noted that the same numeral represents the same or similar elements throughout the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Any one of the terms: “including” or “which includes” or “that includes” as used herein is also an open term that also means including at least the elements/features that follow the term, but not excluding others.

A user generally indulges in cashless transactions in few usual situations. For example, while making expensive purchases, where it is difficult to carry a lot of cash, or in a scenario where he/she may be short of cash. There may be other scenarios as well, where a large number of users resort to cashless transactions at a given time, leading to a sudden spike in overall card based transactions (or cashless transactions through other means, such as digital wallets). Such spike events are normally characterized with special festive seasons, where merchants or payment card services offer a number of incentives on cashless transactions. There may be other rare scenarios where there may be a sudden spike in overall cashless transactions, for example, during demonetization. During demonetization, a government may stop recognizing one or more denominations of local currency as legal tenders. Depending upon the value of denomination, there may be moderate to severe cash crunch in an economy.

While demonetization may be an inconvenience to a citizen, it does favour both the payment services and the economy in general by moving a share of the transactions from cash based to cashless. However, demonetization and its effects are generally temporary, and there is always a tendency of a user to return to cash based transactions, for lack of knowledge of all the benefits of cashless transactions and/or apparent familiarity with cash based transactions. The present disclosure aims to retain the payment card users, as much as possible, to continue using card based (or cashless transactions), even after the passage of the spike event. The present disclosure, which will be discussed in detail in the following paragraphs, aims to identify the users who have shown significant shift from cash based transactions to cashless transactions during the spike event and incentivize such users to continue using cashless transactions. The present disclosure also aims to reward those payment card users who were doing significant amounts of their transactions using cashless means even before the spike event.

The transaction data, pertaining to the payment card users, may be collected from a number of sources, such as purchases made by the payment card users, at various merchants and the ATM withdrawals made by the payment card users, etc. In that manner, the present disclosure may identify such payment card users either through merchant data or directly through payment card data collected for each payment card user. Further, the payment card users may be categorized into a number of categories, based on their transaction data, and incentivized accordingly. The disclosure in the following paragraphs has been described with exemplary environments and scenarios to make the understanding of the disclosure convenient. However, it will be appreciated by a person skilled in the art that the disclosure is not limited to the exemplary scenarios elucidated below.

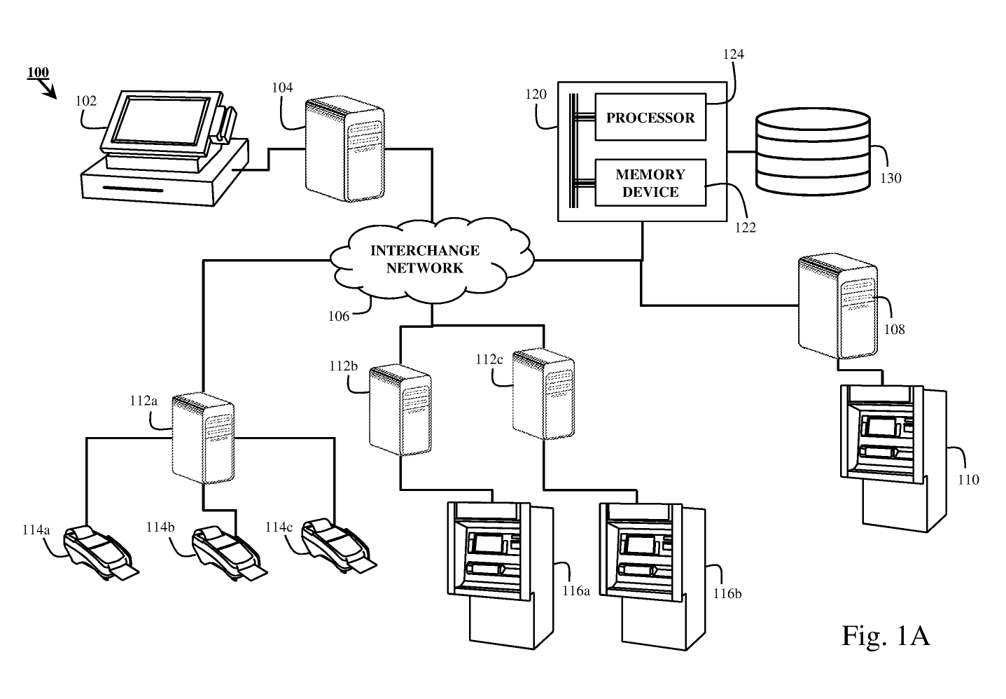

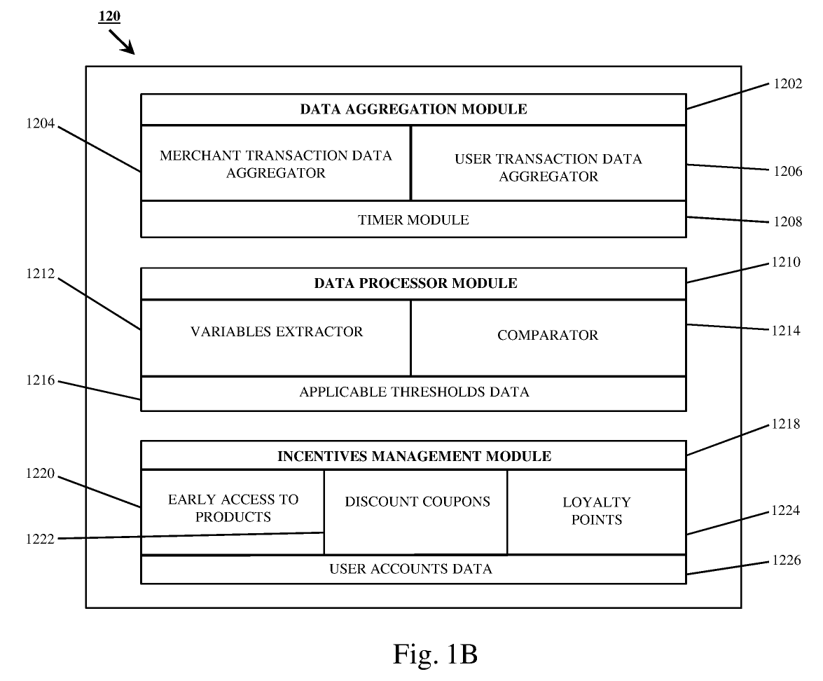

FIG. 1A illustrates an exemplary environment 100 of computing devices to which the various embodiments described herein may be implemented. As shown in FIG. 1, the environment 100 comprises a merchant Point of Sale (POS) terminal 102 associated with a merchant. The merchant here may be a seller of a number of goods and/or services, such as, but not limited to, apparels, footwear, petroleum products and healthcare services, etc. Further, connected to the merchant POS terminal 102 is a merchant acquirer server 104. The merchant acquirer server 104 may be a gateway server associated with an acquirer bank of the merchant. The merchant acquirer server 104 is further connected to an interchange network 106. In various embodiments, the interchange network 106 is an Internet based network configured to exchange transaction data between a plurality of gateway servers, associated with a plurality of respective banks and a plurality of payment servers associated with a payment card service. The interchange network 106 may necessitate that the communications between the plurality of gateway servers and the plurality of payment servers follow standard protocols and be secured using data encryption protocols, such as, but not limited to, SSL or TLS. One example of a standard for exchange of transaction data is ISO 8583: Financial transaction card originated messages—Interchange message specifications.

Further, connected to the interchange network 106 is a payment server 120 associated with the payment card service. The payment server 120 comprises a memory device 122 and a processor 124 operably connected with the memory device 122. The memory device 122 may be a non-volatile memory device, such as, but not limited to, EPROM, EEPORM and Flash Memory. The processor 124 may be, for example, a general purpose processor, an Application Specific Integrated Circuit (ASIC) or a Field Programmable Gate Array (FPGA), etc. The memory device 122 is configured to store machine readable instructions. The machine readable instructions may be loaded into the memory device 122 from a non-transitory machine readable medium or may be downloaded from the interchange network 106 as a computer software program.

FIG. 1B illustrates the payment server 120, in accordance with an embodiment of the present disclosure. The payment server 120 here is envisaged to have a number of functional modules, such as, but not limited to, a data aggregation module 1202, a data processor module 1210 and an incentives management module 1218. The data aggregation module 1202 is further envisaged to make the processor 124 capable of collecting transaction data pertaining to various merchants, via merchant transaction data aggregator 1204, and payment card users, via user transaction data aggregator 1206. However, the transaction data may be collected taking into account all the applicable privacy issues and regulations and wherever required special permissions may be taken from applicable authorities, the merchants and the payment card users. The data aggregation module 1202 is also envisaged to incorporate a timer module 1208 that will regulate how frequently and for what intervals of time the transaction data may be collected.

The data processor module 1210 is envisaged to enable the processor 124 for using the collected transaction data and extract, via variable extractor 1212, various variables associated with card based and cash based transaction at the merchants' ends and/or by the payment card users. The data processor module 1210 may then allow the processor 124 to compare the extracted variables, via the comparator 1214, with the applicable thresholds data 1216 for categorizing the users into a number of categories. The incentives management module 1218 may then allow the processor 124 to award incentives (such as, but not limited to, early access to products 1220, discount coupons 1222 and loyalty points 1224, etc.) based upon the categorization. In that manner, user accounts data 1226 may be used by the processor 124 while awarding the incentives.

Further connected to the payment server 120 is a storage device 130 configured to store transaction data received and/or generated by the payment server 120. In that manner, it is contemplated that the storage device 130 also stores a number of databases, including but not limited to:

a. A database of issuer banks associated with the payment card service;

b. A database of ATM machines associated with the issuer banks;

c. A database of acquiring banks associated with the payment card service; and

d. A database of ATM machines associated with the acquiring banks.

Further connected to the interchange network 106 is an issuer server 108 associated with an issuer bank. The issuer bank is responsible for issuing payment cards to a number of users. The issuer bank may extend cash withdrawal services through the payment cards at an issuer bank ATM 110. Further connected to the interchange network 106 are a plurality of additional acquirer servers 112 (for example, 112a, 112b and 112c). The plurality of additional acquirer servers 112 are further connected to a plurality of additional POS terminals 114 (for example 114a, 114b and 114c) and a plurality of acquirer bank ATMs 116 (for example 116a and 116b). The plurality of additional POS terminals 114 allow users holding the payment cards to make purchases and the plurality of acquirer bank ATMs 116 act as third party ATMs allowing the users to withdraw cash using the payment cards issued by the issuer bank. Various embodiments of the present disclosure may now be understood using the exemplary environment 100 as a reference.

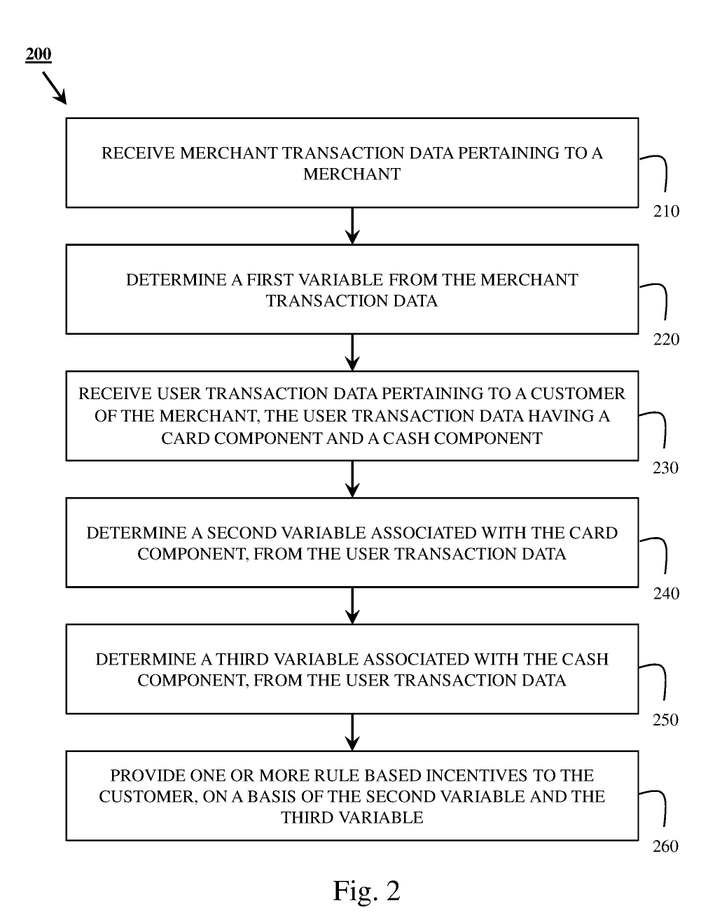

FIG. 2 illustrates a computer implemented method 200 for incentivizing a customer for payment card usage, in accordance with an embodiment of the present disclosure. The performing of the method steps of method 200 involves the processor 124 receiving the machine readable instructions from the memory device 122 and executing the machine readable instructions. At step 210, the processor 124 receives merchant transaction data pertaining to the merchant. The processor 124 receives the merchant transaction data from the merchant acquirer server 104. It is to be noted here that the merchant transaction data pertains only to card based transactions carried out by using payment cards affiliated to the payment card service. The merchant transaction data may comprise, but is not limited to, merchant name and location, merchant POS data, such as date and transaction amounts of transactions going on at the merchant POS terminal 102 and card numbers of the payment cards used to make the transactions. It is contemplated here that the merchant POS data pertains to a plurality of periods of time. For example, the merchant POS data may correspond to data collected on a daily basis, weekly basis, biweekly basis or monthly basis, etc.

At step 220, the processor 124 determines a first variable from the merchant transaction data. The first variable may be indicative of a change in pattern of the merchant transaction data. The need to determine the first variable may arise during a spike event where there is a sudden increase in payment card usage by the users of the payment cards. One such event may be an acute shortage of cash due to demonetization, or too many users making heavy purchases during a festive season or during special offers offered by a merchant on payment card usage for a predetermined period of time. In one embodiment, the first variable is a percentage increase in a total periodic transaction amount for the period of time during the spike event compared to a total periodic transaction amount for the period of time before the spike event. For example, December may be a month where there is a spike in payment card usage. So, the first variable may be a percentage increase in total monthly transaction amounts for the month of December compared to a total monthly transaction amount for the month of November or October, etc.

At step 230, the processor 124 receives user transaction data pertaining to a customer of the merchant. Here, the customer is a user of the payment card associated with the payment card service. Further, the user transaction data comprises a card component and a cash component. The card component corresponds to transactions performed by the customer using his/her payment card, whereas cash component corresponds to cash related transactions performed by the customer, such as ATM cash withdrawal. In one embodiment, the processor 124 receives the user transaction data on the basis of the first variable being higher than a first predetermined threshold value. For example, the percentage increase in the total periodic transaction amount should be at least 85%. Further, in one embodiment, the user transaction data is received on the basis of the user transaction data meeting a predetermined condition. For example, the user transaction data is received for the customer making at least two purchases at the merchant's store. For example, if there is a significant increase in total periodic transaction amounts during the spike event, it is contemplated that the customers of this merchant resorted to cash transactions before the spike event and may be liable to return to cash based transactions once the spike event has passed. This can be further ascertained from the user transaction data.

In one embodiment, the user transaction data comprises user ATM withdrawal data and user POS data. The processor 124 may obtain the user ATM withdrawal data from the issuer server 108 and the additional acquirer servers 112b and 112c. The user ATM withdrawal data here refers to cash withdrawals made by the customer using the payment card at a number of ATMs, such as the issuer bank ATM 110 and/or the plurality of acquirer bank ATMs 116. Similarly, the processor 124 may obtain the user POS data from the acquirer server 104 and the additional acquirer server 112a. The user POS data here refers to transactions made by the customer using the payment card at a number of POS locations including the ones with the merchant. Similar to the merchant transaction data, it is contemplated here that the user transaction data also pertains to the plurality of periods of time. For example, on a daily basis, weekly basis, bi-weekly basis or monthly basis, etc.

At step 240, the processor 124 determines a second variable associated with the card component, from the user transaction data. In one embodiment of the disclosure, the second variable is a percentage increase in a total periodic card component amount for a period of time during the spike event compared to a total periodic card component amount for a period of time before the spike event. For example, December may be the month where there is a spike in payment card usage. So, the second variable may be a percentage increase in total monthly card component amounts for the month of December compared to a total monthly card component amount for the month of November or October, etc.

At step 250, the processor 124 determines a third variable associated with the cash component, from the user transaction data. In one embodiment of the disclosure, the processor 124 determines the third variable on the basis of the second variable being higher than a second predetermined threshold value. For example, the third variable is calculated if the second variable is above 85%. Further, in one embodiment of the disclosure, the third variable is a total periodic cash component amount for a period of time before the spike event. For example, the third component is a total monthly cash component amount for the month of November or October.

At step 260, the processor 124 provides one or more rule based incentives to the customer, on a basis of the second variable and the third variable. The rule based incentives may include, but are not limited to, discounts, loyalty points and early access to certain products, etc. The rule based incentives may be updated in a loyalty database and a payment card account of the customer, maintained by the storage device 130. Alternately, the rule based incentives may be provided to the customer at a mobile handheld device associated with the customer. Table 1 illustrates an exemplary set of rules for providing rule based incentives. Here a first upper threshold is applied to second variable indicative of a high payment card usage and a second upper threshold is applied to the third variable indicative of a high cash usage.

TABLE 1

| S. No. | Segment Description | Incentives |
|---|---|---|
| 1 | Second Variable greater than a | Early and easy access to |
| | first upper threshold, Third | certain products; |
| | Variable greater than a second | Extra Loyalty Points on |
| | upper threshold | payment card usage; |
| | | Least Discount |
| 2 | Second Variable greater than the | Moderate Discount; Moderate |
| | first upper threshold, Third | Loyalty Points on payment |
| | Variable smaller than the second | card usage |
| | upper threshold | |
| 3 | Second Variable smaller than the | High Discounts; Moderate |
| | first upper threshold, Third | Loyalty Points on payment |
| | Variable greater than the second | card usage. |
| | upper threshold | |

It is to be noted here, that the processor 124 need not go through the merchant route to receive the user transaction data of a payment card user. The processor 124 may directly receive the user transaction data of the user of the payment card and use the user transaction data to provide the one or more rule based incentives to the user, as will be seen from the following discussion.

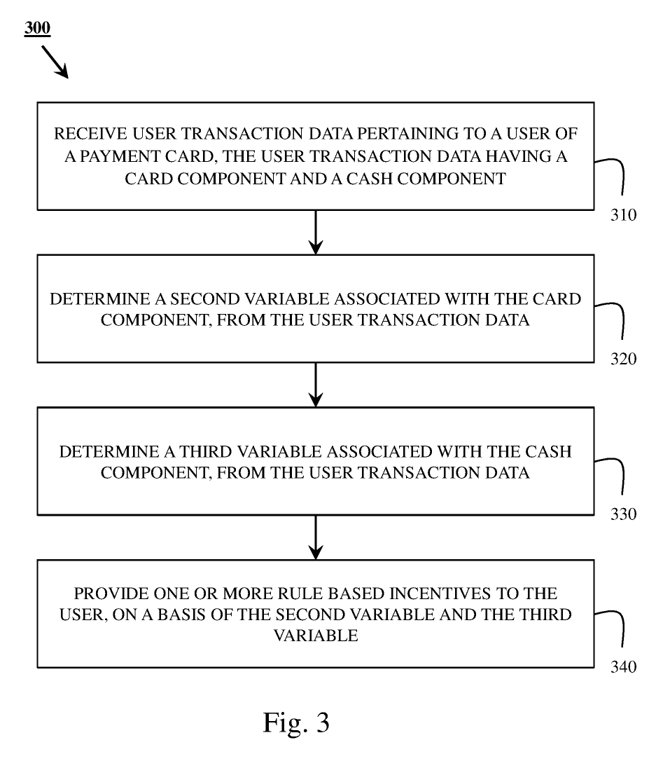

FIG. 3 illustrates a computer implemented method 300 for incentivizing a user for payment card usage, in accordance with another embodiment of the present disclosure. At step 310, the processor 124 receives user transaction data pertaining to a user of a payment card associated with the payment card service. Further, the user transaction data comprises a card component and a cash component. The card component corresponds to transactions performed by the user using his/her payment card, whereas cash component corresponds to cash related transactions performed by the user, such as an ATM withdrawal.

In one embodiment, the user transaction data comprises user ATM withdrawal data and user POS data. The processor 124 may obtain the user ATM withdrawal data from the issuer server 108 and the additional acquirer servers 112b and 112c. The user ATM withdrawal data here refers to cash withdrawals made by the user using the payment card at a number of ATMs, such as the issuer bank ATM 110 and/or the plurality of acquirer bank ATMs 116. Similarly, the processor 124 may obtain the user POS data from the acquirer server 104 and the additional acquirer server 112a. The user POS data here refers to transactions made by the user using the payment card at a number of POS locations including the ones with the merchant. It is contemplated here that the user transaction data pertains to the plurality of periods of time. For example, on a daily basis, weekly basis, bi-weekly basis or monthly basis, etc.

At step 320, the processor 124 determines the second variable associated with the card component, from the user transaction data. In one embodiment of the disclosure, the second variable is the percentage increase in the total periodic card component amount for the period of time during the spike event compared to the total periodic card component amount for the period of time before the spike event.

At step 330, the processor 124 determines the third variable associated with the cash component, from the user transaction data. In one embodiment of the disclosure, the processor 124 determines the third variable on the basis of the second variable being higher than the second predetermined threshold value. Further, in one embodiment of the disclosure, the third variable is the total periodic cash component amount for the period of time before the spike event.

At step 340, the processor 124 provides one or more rule based incentives to the user, on a basis of the second variable and the third variable. The rule based incentives may include, but are not limited to, discounts, loyalty points and early access to certain products, etc. Table 1 illustrates the exemplary set of rules for providing the rule based incentives.

The embodiment of the present disclosure described above offers a number of advantages. First, spike events can be easily identified from merchant and user transaction data and can be used as a leverage for promoting payment card usage. Further, the incentives can be customized as per individual usage pattern of the card users, thereby ensuring the right kind of motivation for payment card usage is provided as per individual needs.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g., RAM) and/or non-volatile (e.g., ROM, disk) memory, carrier waves and transmission media. Exemplary carrier waves may take the form of electrical, electromagnetic or optical signals conveying digital data steams along a local network or a publically accessible network, such as the Internet.

It should also be understood that, unless specifically stated otherwise as apparent from the following discussion, it is appreciated that throughout the description, discussions utilizing terms such as “controlling” or “obtaining” or “computing” or “storing” or “receiving” or “determining”, or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

It should be noted that where the terms “server”, “secure server” or similar terms are used herein, a communication device is described that may be used in a communication system, unless the context otherwise requires, and should not be construed to limit the present disclosure to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the disclosure, it should not be construed to limit the present disclosure to any particular logic flow or logic implementation. The described logic may be partitioned into different logic blocks (e.g., programs, modules, functions, or subroutines) without changing the overall results or otherwise departing from the true scope of the disclosure. Often, logic elements may be added, modified, omitted, performed in a different order, or implemented using different logic constructs (e.g., logic gates, looping primitives, conditional logic, and other logic constructs) without changing the overall results or otherwise departing from the true scope of the disclosure.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1.-5. (canceled)

6. A computer system for incentivizing a user for payment card usage, the computer system comprising:
a memory device configured to store machine-readable instructions; and
a processor operably connected with the memory device, the processor obtaining the machine-readable instructions from the memory device, and being configured by the machine-readable instructions to:
receive user transaction data pertaining to a user of a payment card, the user transaction data having a card component and a cash component;
determine a first variable associated with the card component, from the user transaction data;
determine a second variable associated with the cash component, from the user transaction data; and
provide one or more rule based incentives to the user, on a basis of the first variable and the second variable.

7. The computer system of claim 6, wherein the user transaction data comprises one or more of:
user ATM withdrawal data; and
user Point of Sale (POS) data.

8. The computer system of claim 6, wherein the processor is further configured, by the machine-readable instructions, to determine the second variable on the basis of the first variable being higher than a predetermined threshold value.

9. The computer system of claim 6, wherein the user transaction data pertains to a plurality of periods of time and the first variable is a percentage increase in a total periodic card component amount for a period of time during a spike event, compared to a total periodic card component amount for a period of time before the spike event.

10. The computer system of claim 6, wherein the second variable is a total periodic cash component amount for a period of time before a spike event.

11.-13. (canceled)

14. A computer implemented method for incentivizing a user for payment card usage, the method comprising:
receiving user transaction data pertaining to a user of a payment card, the user transaction data having a card component and a cash component;
determining a first variable associated with the card component, from the user transaction data, wherein the user transaction data pertains to a plurality of periods of time and the first variable is a percentage increase in a total periodic card component amount for a period of time during a spike event, compared to a total periodic card component amount for a period of time before the spike event;
determining a second variable associated with the cash component, from the user transaction data, wherein the second variable is a total periodic cash component amount for the period of time before the spike event; and
providing one or more rule based incentives to the user, on a basis of the first variable and the second variable.

15. The computer implemented method of claim 14, wherein the user transaction data comprises one or more of:
user ATM withdrawal data; and
user Point of Sale (POS) data.

16. The computer implemented method of claim 14, wherein the second variable is determined on the basis of the first variable being higher than a predetermined threshold value.

17. (canceled)

18. A non-transitory machine-readable medium, including machine-readable instructions stored thereon, which when executed by a processor, cause the processor to:
receive user transaction data pertaining to a user of a payment card, the user transaction data having a card component and a cash component;
determine a first variable associated with the card component, from the user transaction data;
determine a second variable associated with the cash component, from the user transaction data; and
provide one or more rule based incentives to the user, on a basis of the first variable and the second variable.

19. (canceled)

20. The computer system of claim 6, wherein the user is a customer of a merchant; and
wherein the processor is further configured, by the machine-readable instructions, to:
receive merchant transaction data pertaining to the merchant; and
determine a third variable from the merchant transaction data.

21. The computer system of claim 20, wherein the merchant transaction data comprises merchant Point of Sale (POS) data pertaining to the merchant.

22. The computer system of claim 21, wherein the merchant POS data pertains to a plurality of periods of time and the third variable is a percentage increase in a total periodic transaction amount, for a period of time during a spike event, compared to a total periodic transaction amount, for a period of time before the spike event.

23. The computer system of claim 20, wherein the processor is further configured, by the machine-readable instructions, to receive the user transaction data on the basis of the third variable being higher than a predetermined threshold value.

24. The computer system of claim 20, wherein the processor is further configured, by the machine-readable instructions, to receive the user transaction data on the basis of the user transaction data meeting a predetermined condition.

25. The computer implemented method of claim 14, wherein the user is a customer of a merchant; the method further comprising:
receiving merchant transaction data pertaining to the merchant, wherein the merchant transaction data comprises merchant Point of Sale (POS) data pertaining to the merchant; and
determining a third variable from the merchant transaction data, wherein the merchant POS data pertains to a plurality of periods of time and the third variable is a percentage increase in a total periodic transaction amount, for the period of time during the spike event, compared to a total periodic transaction amount, for the period of time before the spike event.

26. The computer implemented method of claim 25, wherein the user transaction data is received on the basis of the third variable being higher than a predetermined threshold value.

27. The computer implemented method of claim 25, wherein the user transaction data is received on the basis of the user transaction data meeting a predetermined condition.

28. The non-transitory machine-readable medium of claim 18, wherein the user is a customer of the merchant; and
wherein the machine-readable instructions, when executed by a processor, further cause the processor to:
receive merchant transaction data pertaining to a merchant; and
determine a first variable from the merchant transaction data.
